(19) United States
(12) Patent Application Publication
(10) Pub. No.: US 2013/0333333 A1
(43) Pub. Date: Dec. 19, 2013

(54) FILLING STATION AND METHOD OF FILLING AN ENVELOPE

(71) Applicant: BOEWE SYSTEC GmbH, Augsburg (DE)

(72) Inventors: Joseph BATZER, Leitershofen (DE); Helmut FOERG, Grossaitingen (DE); Thomas HUBER, Stadtbergen (DE); Reinhard SEILER, Aindling (DE)

(21) Appl. No.: 13/969,432

(22) Filed: Aug. 16, 2013

Related U.S. Application Data
(63) Continuation of application No. PCT/EP2011/074316, filed on Dec. 30, 2011.

(30) Foreign Application Priority Data
Feb. 17, 2011 (DE) 102011004346.2

(51) Int. Cl. B43M 3/04

(52) U.S. Cl. CPC B43M 3/04
USPC 53/473; 53/381.5

(57) ABSTRACT

A filling station for filling an envelope with a filling material includes a filling area, a holder configured to hold an envelope to be filled in the filling area while it is being filled and to release the filled envelope once it has been filled, at least one opener configured to open the envelope to be filled, an inserter configured to insert a filling material into the opened envelope to be filled, and a transport unit configured to move a subsequent envelope into the filling area while the envelope to be filled is being filled, the opener being configured to open the subsequent envelope before the filled envelope has completely left the filling area.

### CROSS-REFERENCE TO RELATED APPLICATIONS

This application is a continuation of copending International Application No. PCT/EP2011/074316, filed Dec. 30, 2011, which is incorporated herein by reference in its entirety, and additionally claims priority from German Application No. 102011004346.2, filed Feb. 17, 2011, which is also incorporated herein by reference in its entirety.

The present invention relates to the field of paper handling, in particular to a filling station for filling an envelope, to a paper handling system, and to a method of filling an envelope in a filling station.

### BACKGROUND OF THE INVENTION

Various enveloping principles are known from conventional technology. U.S. Pat. No. 7,475,522 B2 shows a filling station with direct feeding of the envelopes from above. Coming from the envelope leader, an envelope moves against a stop, is received by two worm wheels, is separated and is vertically inserted into the filling plane. Once the envelope has been opened and filled, the stop is opened and the envelope is transported out of the filling station. EP 1 275 523 A describes an approach to inserting a material into an envelope, the envelopes being fed from above, separated by worm wheels and fed to the filling station by means of the movement of the worm wheels. EP 1 473 173 A describes an enveloping machine wherein the envelopes are fed to the filling station from below. Feeding is performed by means of worm wheels, which are enabled for envelope output subsequent envelope filling.

The above-described filling stations for enveloping machines have short travel paths in the feeding of the envelopes to the filling station. In order to transport a subsequent envelope into the filling station, it is useful to bridge a movement path, which essentially corresponds to the thickness of the envelope and/or to the spacing of a screw channel. While the filled envelope is removed, the next envelope is already available for envelope opening. Avoidance of long travel paths and of the long dead times resulting therefrom enables that feeding of the envelopes to the filling need not be performed at high speeds; rather, low speeds may be used. Therefore, said approaches are suitable for large cycle outputs. U.S. Pat. No. 7,475,522 B2 relates to an embodiment of a filling station wherein the cycle output may amount to 30,000 envelopes/h. The short travel paths and the low speeds also enable compact design of the system.

However, the above-described known approaches or solutions are disadvantageous in that two of the three known solutions, namely the approaches described in U.S. Pat. No. 7,475,522 B2 and in EP 1 275 523 B1, disclose feeding of the envelopes from above. This is disadvantageous since in case of feeding being performed from above, a subsequent envelope can get caught in the window of the preceding envelope.

In addition, the three above-described approaches, wherein envelope filling is performed into an envelope with the flap located at the top and the throat opening located at the bottom, involve increased effort for preventing a collision of the material being introduced at the throat opening, and thereby significantly restrict format and shape flexibility. In addition, all of the above-described solutions provide a approaches without any lateral guide and/or without the envelope being spread open in the filling process, which considerably reduces process reliability and lowers the filling limit. Moreover, design and operation are expensive due to the worm wheels used.

According to the three solutions described above, opening the envelope as well as keeping it open are performed exclusively by means of blow air. However, this is reliable to a limited extent only, since, on the one hand, already minor adhesions on the inside of the envelope make it significantly more difficult to open the envelope by means of blow air only, and, on the other hand, keeping the envelope open by means of blow air only may result in that the filling material is partly or even completely “blown out” of the envelope.

In addition, the known solutions may use a stop in the form of a separate element in the US patent, and in the form of worm wheels in the EP patent applications. This stop is extremely disadvantageous. The envelope rests at this stop while being filled, so that it is useful to control the stop synchronously with the slide so as to ensure reliable filling of the envelope and reliable removal at the same time. The approaches described therefore involve a large amount of expenditure in terms of control in order to correctly control the stop for releasing same.

### SUMMARY

According to an embodiment, a filling station for filling an envelope including a filling material may have: a filling area, a holder configured to hold an envelope to be filled in the filling area in a stationary manner while it is being filled, and to release the filled envelope once it has been filled, at least one opener configured to open the envelope to be filled, an inserter configured to insert a filling material into the opened envelope to be filled, and a transport unit configured to move a subsequent envelope into the filling area while the envelope to be filled is being filled, and the opener being configured to open the subsequent envelope before the filled envelope has completely left the filling area.

According to another embodiment, a paper handling system may have: one or more paper handling components for providing a filling material; a filling station as claimed in claim 1; and a controller effective to control the paper handling component and the filling station.

According to another embodiment, a method of filling an envelope with a filling material may have the steps of: holding, in a stationary manner, an envelope to be filled in a filling area, opening the envelope to be filled, introducing a filling material into the opened envelope to be filled, moving a subsequent envelope into the filling area while the envelope to be filled is being filled, releasing the filled envelope, and opening the subsequent envelope before the filled envelope has completely left the filling area.

The present invention further provides a paper handling system comprising one or more paper handling components, such as a cutter, a merger, a collating station, a folding unit and/or a gathering web having one or more insert leaders in order to provide a filling material, and comprising a filling station in accordance with embodiments of the invention, a controller being additionally provided which is operative to control the paper handling component and the filling station.

In accordance with an embodiment, the holder may comprise one or more segment rollers, one or more suction units acting upon the envelope flap from above or from below, one or more pliers, one or more lateral guide rails and/or a suction unit which acts upon the envelope body from above and may be configured as a suction ledge or suction sheet.

In accordance with an embodiment, the holder is configured to hold an envelope at its envelope flap.

In accordance with an embodiment, the filling station includes a movable filling aid configured to be moved into the envelope to be filled, the transport means including an envelope feeder configured to feed the subsequent envelope so as to hold part of the subsequent envelope in a deflected manner in relation to the rest of the envelope and away from the envelope to be filled, and to release the deflected part of the envelope before filling of the envelope to be filled is completed. The holder is configured to hold the subsequent envelope in the filling area once the filled envelope has been released. The envelope feeder may be configured to hold an envelope bottom of the subsequent envelope in a downwardly deflected manner in relation to the rest of the subsequent envelope and to thereby hold it away or distant from the envelope to be filled. The filling aid may be configured to move into the subsequent envelope once filling of the preceding envelope has been completed and before removal of the filled envelope from the filling station is completed. In addition, the envelope feeder may be configured to receive the subsequent envelope below the filling area.

In accordance with an embodiment, the envelope feeder may include a rotatable member or one or more movable pairs of fingers so as to hold part of the subsequent envelope in a deflected manner, e.g. downwardly deflected, in relation to the rest of the envelope and away from the envelope to be filled. The envelope bottom may be received in a bay, for example, so as to effect the deflection without the envelope bottom being fixed in place in the bay. In other embodiments, a clamping element may optionally be provided for fixing the envelope bottom in place. The envelope bottom is released before filling of the envelope is completed, so that it is no longer deflected. The rotatable member may be configured, for example, in the form of one or more rollers, one or more wheels, or a drum, first and second receptacles and possibly even one or more further receptacles being provided along a circumference of the rotatable member for receiving the envelope bottom.

In accordance with embodiments, the envelope feeder may further comprise a transport device so as to feed an envelope, it being possible for the transport device to be configured to feed an envelope in the material transport direction, counter to the material transport direction, or perpendicularly to the material transport direction. The transport device may further be configured to receive a plurality of envelopes in a shingled manner. In accordance with an embodiment, the further transport device includes a suction-belt transport device which is deactivated while the filling aid is moved into the envelope, and which Is activated while the envelope is being filled.

The filling station may further include a removal unit, which outputs a filled envelope and is active once the filling material has been inserted into the envelope. Moreover, the insertion means may comprise a filling slide provided to insert a filling material into the opened envelope. In accordance with a further embodiment, the filling slide may further be configured to output a filled envelope.

In accordance with embodiments of the invention, the filling aid includes a guide, one or more fingers, a sheet metal, or a packing bag.

Moreover, a further means may be provided in the filling station for opening the envelope disposed at the filling position, for example an air blast supply means, i.e. for separating the envelope bottom from the envelope top. Instead of the suction-belt transport device, the transport device may also include a segment transport device, a pliers transport device, a finger transport device, or a roller transport device. Moreover, a means may be provided in the filling station for avoiding interaction between an envelope being moved into the filling area and an envelope being filled or discharged (removed).

Embodiments of the invention thus provide a new approach to filling envelopes at a high cycle output within a wide format spectrum, the advantages of the known solutions having been retained, in particular, while their disadvantages have been eliminated. In accordance with embodiments of the invention, two envelopes are located one above the other in the filling area at the same time during operation, the envelope to be filled and the subsequent envelope. Filling aids are employed for ensuring the filling process. Active elements such as worms or transport wheels, which are used by the known solutions, are replaced by passive elements and/or alternative embodiments; for example, instead of the worms/transport wheels, a passive element is employed for separating the at least two envelopes located within the filling station, e.g. an element in the form of a slope, a holder or an edge or the like.

Embodiments of the invention are advantageous since no stop is required, so that the problems associated therewith, in particular the high control expenditure, are avoided.

In accordance with further embodiments of the invention, envelope feeding is performed such that a window of an envelope faces downward, so that guidance for the filling material, e.g. adaptation to the throat opening shape, is easier to implement. In addition, the envelopes to be filled are arranged to be positioned one below the other, which results in the next envelope being ready to be filled already once the filled envelope has been removed.

One advantage of the inventive solution consists in that an enveloping machine is provided which has a high cycle output, can process a large format spectrum, comprises a low number of components and functional parts that may be used, comprises compact system space and/or little enclosed space, comprises short travel paths of envelopes and filling material, and shows no decrease in performance as the format height of the envelope increases.

One advantage of embodiments of the invention consists in that feeding of the envelopes may be effected with the windows and the flaps located at the bottom, compact dimensions of the system being achieved at the same time. In addition, one may operate with low filling rates, and the number of functional parts that may be used is low. The feeding performance is independent of the envelope height, i.e. of the distance between the envelope bottom and the envelope throat opening since the feeder is aligned to the hinge line (=edge where the flap of the envelope is attached to the envelope body). The performance potential may be increased since the envelope need not be transported counter to the filling direction.

### BRIEF DESCRIPTION OF THE DRAWINGS

Embodiments of the present invention will be detailed subsequently referring to the appended drawings, in which:

FIG. 1 shows a schematic, lateral sectional view of a filling station in accordance with an embodiment of the invention;

FIG. 2 shows a schematic, lateral sectional representation of a filling station in accordance with a second embodiment of the invention,

FIGS. 3 to 15 show representations of the process of envelopes being filled while using the inventive filling station by means of a representation of the condition of the filling station and the envelopes and materials located therein at different points in time between a starting position (t=t₀) and an end of the filling process (t=t₁₂); and

FIG. 16 shows a schematic representation of a paper handling system comprising an enveloping machine with a filling station in accordance with embodiments of the present invention.

### DETAILED DESCRIPTION OF THE INVENTION

In the following description of the embodiments, elements which are identical or have identical functions are provided with identical reference numerals.

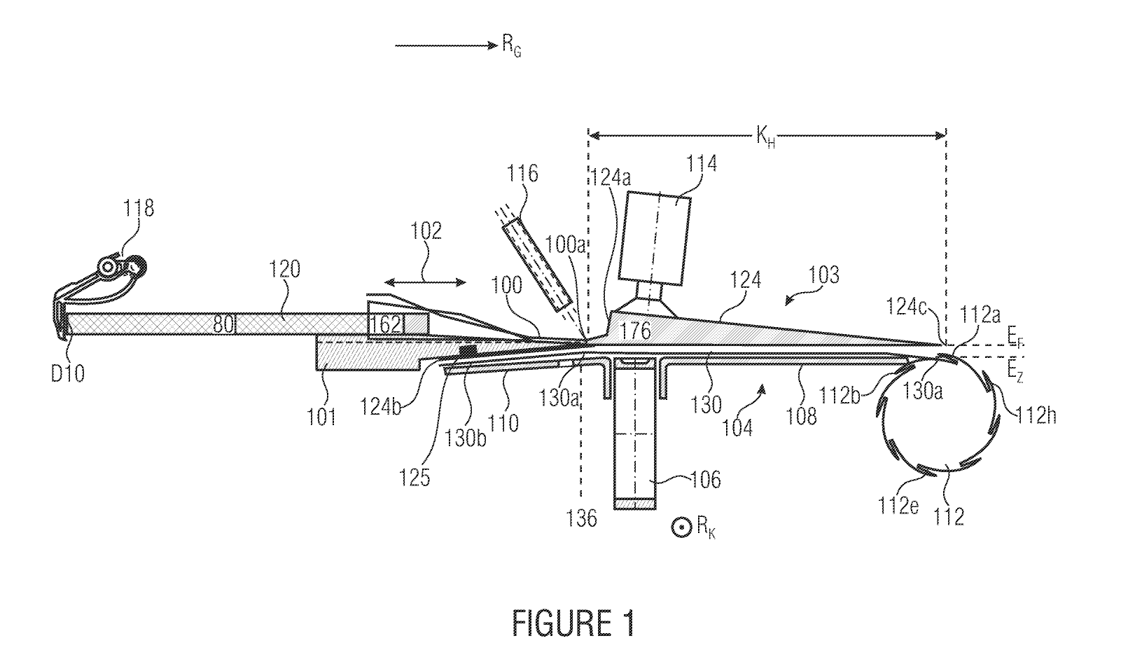

FIG. 1 shows a first embodiment of a filling station. The filling station includes a movable filling aid 100, the mobility of which is indicated by arrow 102. The movable filling aid 100 includes, for example, a plurality of fingers which are arranged in parallel next to one another and may be at least partly moved into an envelope in that the filling aid 100 is moved, so that the filling aid 100 is arranged in a throat opening of the envelope. The filling aid 100 includes ends 100a which during movement toward an envelope are the first to come into contact with same. In the embodiment shown, the fingers 100 taper in the direction of the ends 100a. The filling aid 100 may be movably arranged on a material feeding sheet 101, but may also be mounted independently thereof.

The filling aid 100 is arranged within a filling area 102 which starts from the filling aid 100 and extends along the material transport direction R_{G} by a distance which essentially corresponds to an envelope height K_{H} (=dimension of the envelope between the envelope bottom and the hinge line=edge where the flap of the envelope is attached to the envelope body) of an envelope pulled up onto the filling aid 100. A filling plane E_{F} is defined essentially by a plane wherein the fingers of the filling aid 100 extend and/or wherein the top surface of the envelope pulled up (=side where the flap is arranged) is disposed.

Moreover, the filling station includes an envelope feeder 104 which feeds envelopes, which are transported by means of a suction-belt transport device 106 along a direction perpendicular to the material transport direction R_{G}, to the filling area. The envelope feeder 104 includes a receptacle 108, upon which an envelope body of an envelope fed by means of the suction-belt transport device 106 rests. The receptacle 108 defines an envelope feeding plane E_{z}, which is arranged below and in parallel with the filling plane E_{F}. The filling area extends vertically to the support and/or the plane E_{Z}. Depending on how a subsequent envelope is fed in, said envelope may be arranged to be offset in relation to the envelope currently being filled, so that the longitudinal and/or transverse sides of the envelopes are not aligned. That area wherein the envelopes are arranged to completely or partly overlap is considered to be the filling area.

Moreover, the envelope feeder 104 includes a portion 110 which is located upstream in the material feeding direction R_{G} and on which an envelope flap of an envelope fed by the suction-belt transport device 106 rests. The flap support 110 extends from the suction-belt transport device 106 counter to the material transport direction R_{G} and is arranged below the filling aid 100 and below the material feeding sheet 101. A roller 112 is provided at a position which is arranged downstream from the suction-belt transport device 106 in the material feeding direction R_{G}. The roller 112 includes a plurality of receptacles or bays 112a-112h arranged in a distributed manner along the circumference of the roller 112. The receptacles 112a-112h serve to receive an envelope bottom during transport into the filling area, so that the envelope bottom is downwardly deflected in relation to the rest of the envelope, as is illustrated by the receptacle 112a.

The filling station further includes one or more suction heads 114, which cause an envelope throat to open. One or more blow air nozzles 116 are provided for assisting opening of the envelope.

The filling station further includes a filling slide 118 configured to move a filling material 120 in the material transport direction R_{G} and to insert it into an envelope provided at the filling station. In the embodiment shown in FIG. 1, the filling slide 118 further serves to transport the filled envelope away, as is shown in the right-hand area of FIG. 1. Moreover, the filling station includes a clamping element 125, e.g. in the form of a suction unit in or at the sheet 101 which serves to fix in place a flap of an envelope during filling.

FIG. 1 depicts a situation wherein a first envelope 124 is waiting to be filled and is located, in the filling area 103, at that filling position at which the filling aid 100 may be moved into the envelope 124 (the envelope throat 124a). The filling aid serves to guide the material during insertion and to laterally protect it in accordance with embodiments. While using a blow air blast supplied by the nozzle 118, the envelope throat 124a was already opened, and the filling aid 100 is inserted. The suction unit 114 engages with the underside or rear side of the envelope 124 so as to open the envelope and keep it in the opened state. The flap 124b is arranged below the sheet 101 and is fixed in place, or held, by the suction unit 125. The envelope bottom 124c is released, i.e. it is not downwardly deflected in relation to the rest of the envelope. By means of the slide 124, the filling material is moved in the direction of the opened envelope 124. In addition, a second, non-filled envelope 130 is shown which is or was moved into the filling area 103 to a position underneath the envelope 124 by means of the envelope feeder 104. The throat opening 130a of the second envelope rests on the plate 108 and is located, with regard to the material transport direction R_{G}, at a position 136, where also the throat 124a of the envelope 124 is arranged at the filling position. The envelope bottom 130a is arranged, in the bay 112a, such that it is downwardly deflected. In this manner, a movement of the envelope 130 in the material transport direction R_{G}, is prevented, and the upper envelope 124 may be discharged after the filling process without the lower envelope 130 being moved along with it. Immediately after discharge of the upper envelope 124 is started, the lower envelope is ready to be filled, and its throat is opened by the blow air aid and the suction unit, so that the filling aid may be inserted. The flap 130b rests upon the flap support 110 and is held by the suction unit 125 as soon as the flap of the filled envelope 124 has released the suction unit. The envelope bottom 130a is downwardly deflected and is released once the suction unit 125 has been activated, so that moving of a subsequent envelope into the filling area can be started.

The functionality of the filling station described with regard to FIG. 1 is such that feeding of an envelope removed from an envelope leader is effected from the side, a window and an envelope flap being located at the bottom. The envelope is transported from the side by means of the envelope feeder, there is no movement in the material direction, and instead, the one or more filling aids are actively inserted into the envelope. The envelopes are transported into the filling station from below, for example via the suction belt 106, with open flaps, and are positioned in the filling area. The envelope is held, while being transported into the filling station, in a guide, the rear edge separation, on the side of the bottom, in the example shown in FIG. 1, in one of the receptacles 112a-112h which is not located at the filling position. Lateral positioning may be effected, e.g., via stops, edges or traps or also directly via the suction-belt transport device. The envelope transported into the filling station in this manner is opened by means of an air blast supplied via the blow air tabs 116 once discharging of the preceding envelope has started, and is subsequently held open by the suction head and/or the plurality of suction heads 114. In parallel herewith, the filling process is started, wherein lateral filling aids 100 are inserted into the opened envelope, span it open and protect the inflowing material 120 from hitting an envelope side or the envelope bottom and against envelope adhesion. The envelope may be fixed in place or held in different ways during the filling process, for example by fixing the envelope in place on the lateral filling aids by fixing the envelope flap in place on the underside of the envelope feeder via suction areas, or by a different, suitable configuration.

The filling material 120 is pushed into the opened envelope via the filling slides 124, and in the embodiment shown in FIG. 1, the rear edge separation is already detached, in that, in the embodiment shown, the roller 112 is made to latch one unit further on. In addition, envelope fixing is released, and the envelope is transported out of the filling station, for example by means of the filling slides.

Already while the envelope is being filled, the next envelope is laterally pushed, by means of the suction-belt transport device 106, to a position below the envelope located in the filling station, the envelope bottom here being pushed into the next free bay of the rear edge separation depicted as a segment drum in FIG. 1, here into bay 112b. In this manner, one ensures that the envelope which has been filled does not take along with it the underlying envelope when the former is being discharged.

Performing the above-described processes, namely filling/removing and feeding a new envelope, in parallel enables that a further envelope is available immediately after filling and prior to completion of removal of the filled envelope, whereby high performances are achieved. In contrast to known solutions, the inventive approach is advantageous since the envelope height has no influence on the feeding performance. The envelope height is that dimension of the envelope which extends from the envelope bottom to the edge where the flap of the envelope is attached to the envelope body, the so-called hinge line. This independence of the envelope height is achieved in that inward transport of the envelope is performed at the height of the hinge line.

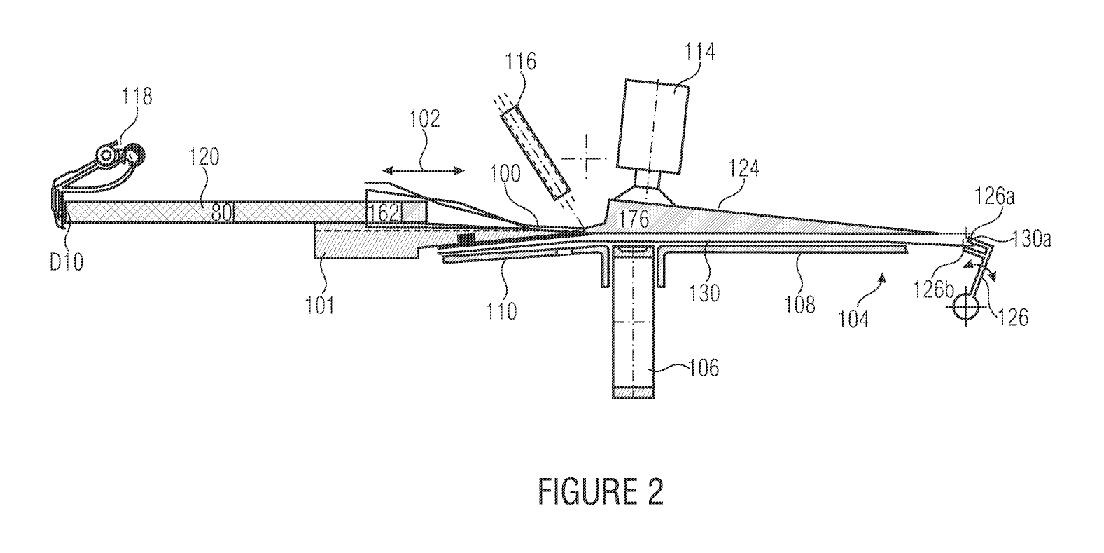

FIG. 2 shows a further embodiment of the filling station, which differs from the embodiment described by means of FIG. 1 only in terms of the configuration of the rear edge separation, so that renewed description of those elements described by means of FIG. 1 which are only schematically shown in FIG. 2 will be dispensed with. As may be seen from FIG. 2, the roller 112 shown in FIG. 1 is replaced by a reciprocating lever 126 which includes a pair of fingers 126a, 126b. The lever 126 may be pivoted between a first position closer to the suction-belt drive 106 and a second position further away from the suction-belt transport device, FIG. 2 showing the first position. The functionality is similar to that of the roller 112; however, the lever 126 releases the envelope bottom once the envelope 124 has been positioned at the filling position, and is pivoted back to the first position so as to hold an envelope bottom 130a of a subsequent envelope 130. Once the envelope 124 has been filled, it is removed, and the envelope bottom 130a of the subsequent envelope 130 arranged in the filling area is released by moving the lever 126 from the first position to the second position, and the lever 126 pivots back to the first position.

By means of the following figures, the function of the inventive filling station will be explained in more detail on the basis of a configuration of the filling station as was explained by means of FIG. 1. The operational sequence will be explained in accordance with the following boundary conditions: feeding of the envelopes is performed from the side, said feeding of the envelopes being clocked and being effected at a predetermined distance between the envelopes. The windows in the envelopes are arranged at the bottom, and in the filling area of the filling station, two envelopes are arranged one below the other. A suction unit for opening the envelope has been dispensed with. The envelope is opened by means of blow air.

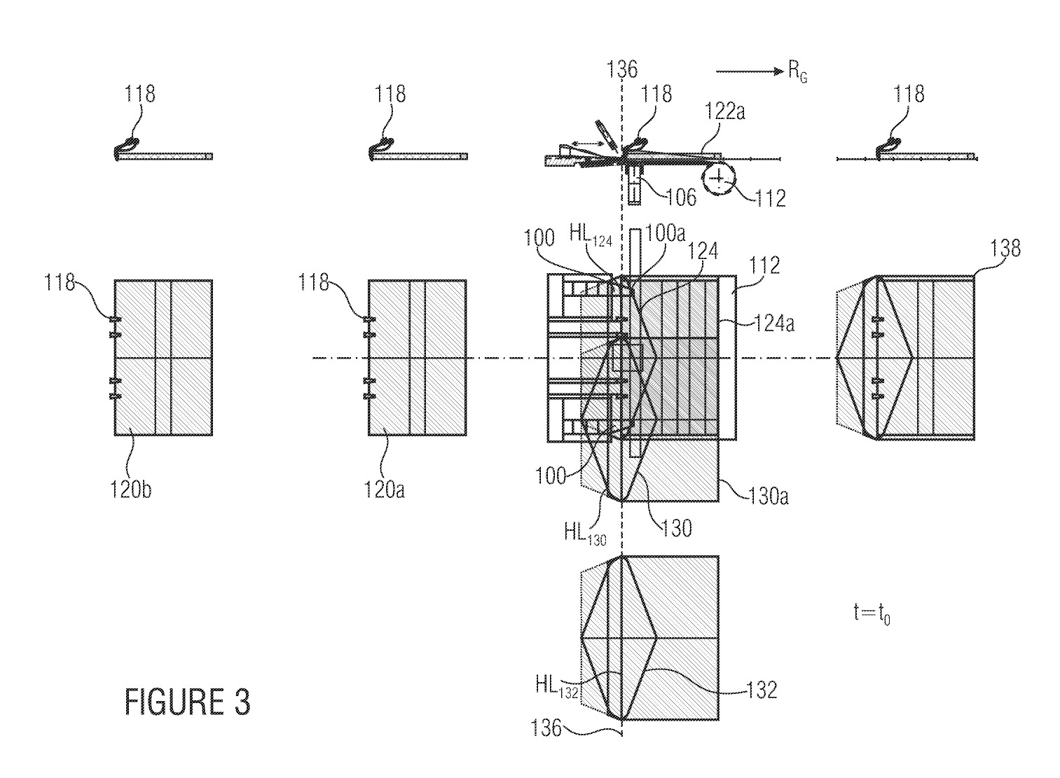

FIG. 3 shows the starting situation at a time t=t₀. In the top area of FIG. 3, a lateral, schematic representation of the filling station of FIG. 1 is shown, and a top view is shown in the bottom area. The envelope 124 is arranged at the filling position, and the subsequent envelope 130 is already partly inserted into the filling area at a position below the envelope 124. In addition, a subsequent envelope 132 is shown, which is ready for being inserted into the filling station, following the envelope 130. The envelope 124 is located at that filling position at which its envelope section (hinge line HL₁₂₄) is located at the position 136. In this position, the filling aids 100 may move into the throat opening of the envelope 124. FIG. 3 shows that the filling aids 100 are already arranged inside the envelope and that a filling material 122a has already been inserted. The subsequent envelope 130 as well as the envelope 132 are fed in by means of the suction-belt transport device 126, also at the position 136, i.e. the hinge line HL₁₃₀ and the hinge line HL₁₃₂ of envelopes 130 and 132, respectively, are arranged at the same position 136—in the material transport direction R_{G}—at which a hinge line of the envelope to be filled, which is located in the filling position, is arranged. The envelope bottom 124a of the envelope 124 has already been released, and the envelope bottom 130a of the envelope 130 being fed is received in the bay 112a and held there. FIG. 3 further shows an envelope 138 which has already been filled and transported out of the filling station as well as further groups of filling materials 122a and 122b, which are moved to the filling station so as to be inserted there into the envelope 130 and/or the envelope 132.

One may further recognize in FIG. 3 that the filling aids 100 are arranged in a position in which they were moved in the direction of the material transport direction R_{G} starting from a rest position, so that their front portions 100a are arranged in the envelope 124, more specifically at a position downstream along the material feeding direction R_{G} in relation to the hinge line HL₁₂₄. In terms of the elements of the filling station one may recognize that the front ends of the filling aids 100a extend, in a top view, across part of the suction belt 106. In FIG. 3, filling of the envelope 124 has already been completed, i.e. the filling material is inside the envelope, so that the latter may be closed by folding down the flap in a subsequent processing step. The filling aid(s) is/are already on its/their way back from the filling position to the rest position.

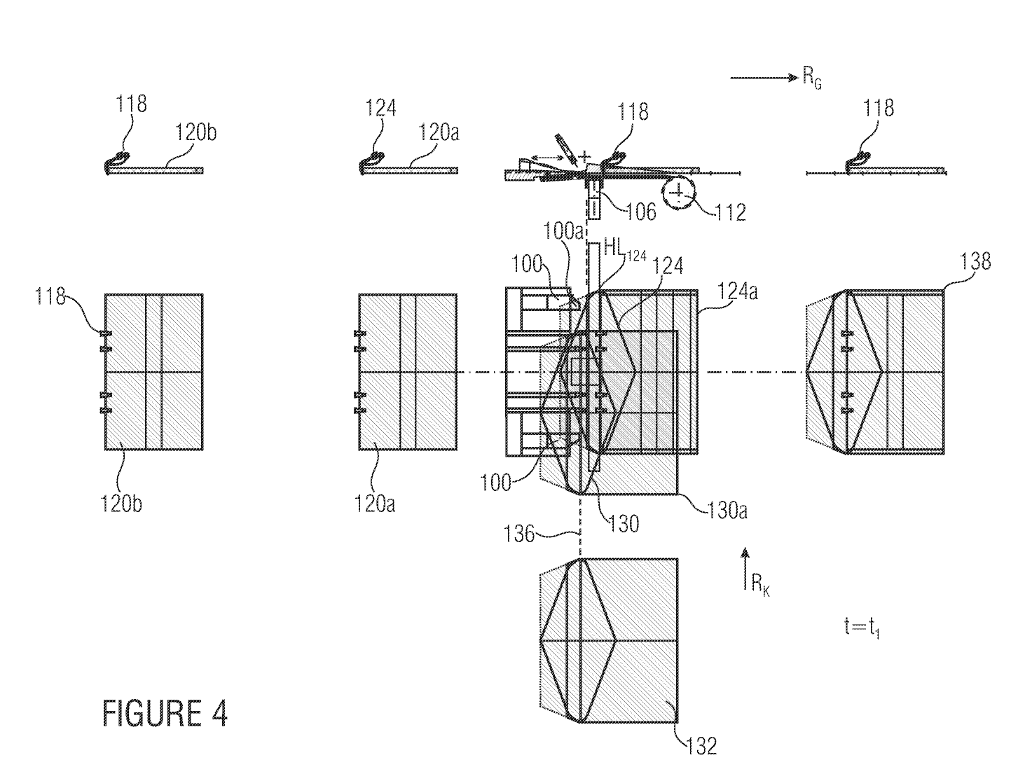

FIG. 4 shows the situation of a time period t₁ after the starting situation in FIG. 3. The filled envelope 124 was moved in the material transport direction R_{G}, as may be seen from a comparison of FIGS. 3 and 4; in FIG. 4 one can see that the hinge line HL₁₂₄ of the envelope 124 has left the position 136 and is now arranged behind the belt transport device in the transport direction R_{G}. The filling aids 100 were returned to their rest positions, so that their tips 100a are arranged, in a top view, at a distance from the belt 106 (upstream from the position 136 in the material transport direction R_{G}), as may be seen, in a top view, by means of the distance between the front tip 100a and the belt 106. The envelope 130 and the envelope 132 were moved further in the envelope feeding direction R_{K}, so that the overlapping area of the envelopes 124 and 130 is larger than that in FIG. 3.

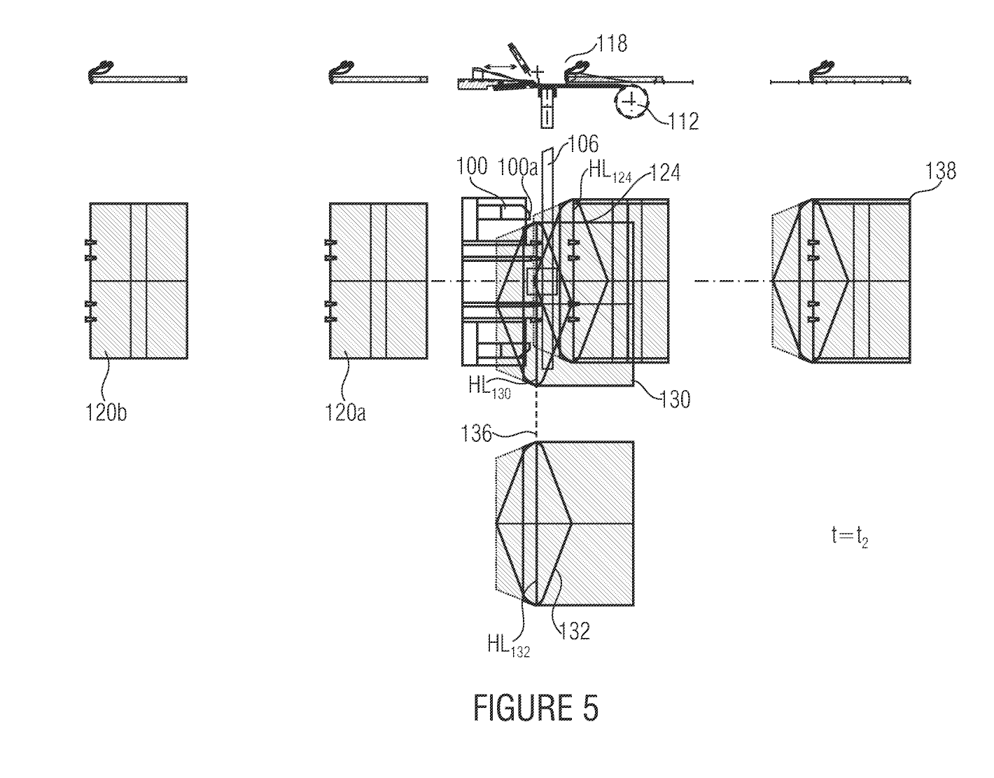

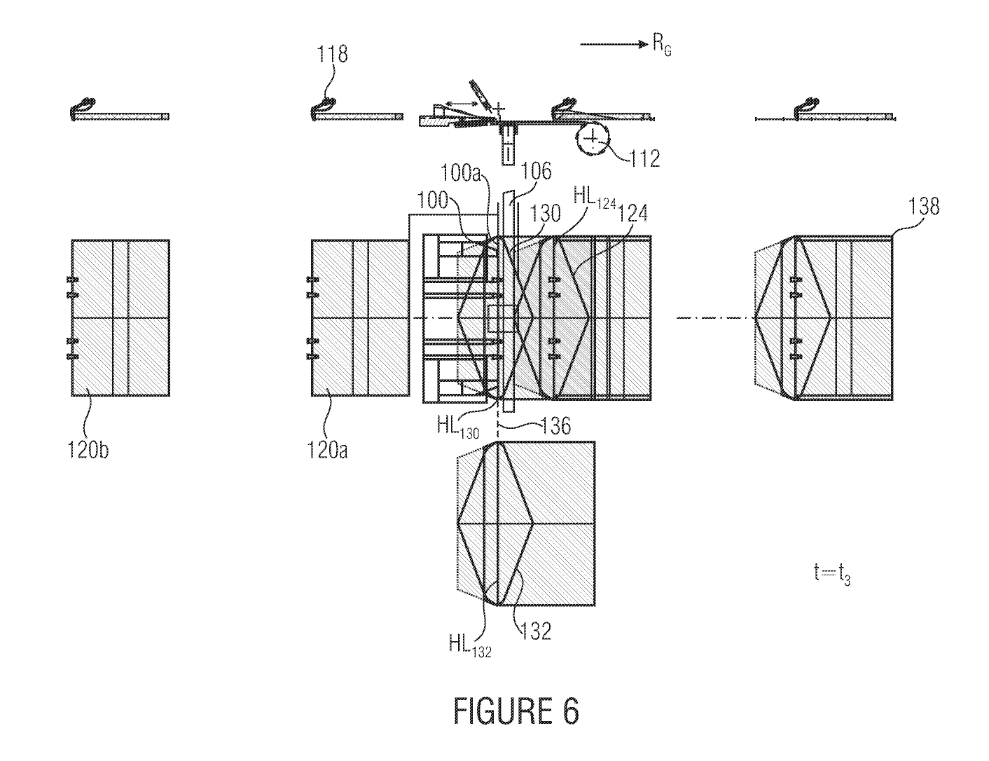

Movement of the envelopes 130 and 132 continues, as is shown by means of FIGS. 5 (t=t₂) and 6 (t=t₃), so that the situation shown after t=t₃ in FIG. 6 is achieved, wherein the envelope 130 has completely arrived in the filling station, more specifically in the filling area 103. The filling aids 100, too, are in their retracted positions, wherein the tips 100a of the filling aids are arranged, in relation to the elements of the suction-belt transport device 106, at a distance from same, in a top view. As may further be seen from FIGS. 4 to 6, the groups of filling materials 120a and 120b were moved in the material transport direction R_{G}, so that the group of materials 120a to be inserted into the envelope 130 is located directly in front of the filling station.

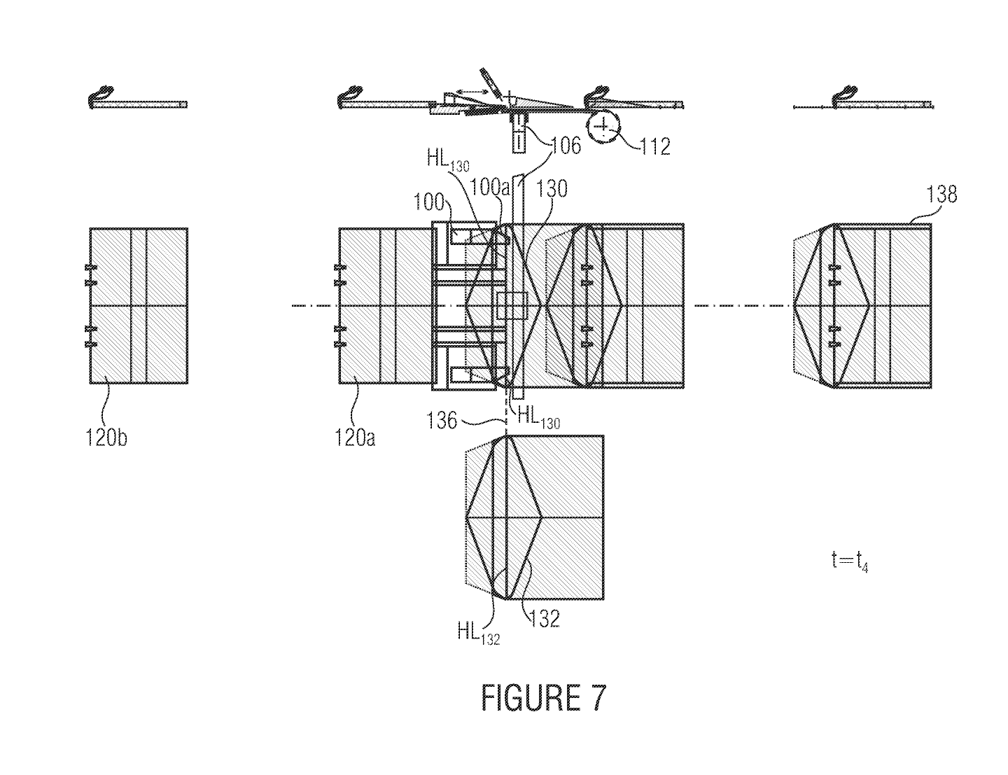

FIG. 7 shows the situation after t=t₄, once the wheel 112 was actuated so as to move it further by one bay so as to move the bay 112a shown in FIG. 1 to the position of the bay 112h shown in FIG. 1. This results in that the envelope bottom 130a of the envelope 130 is released.

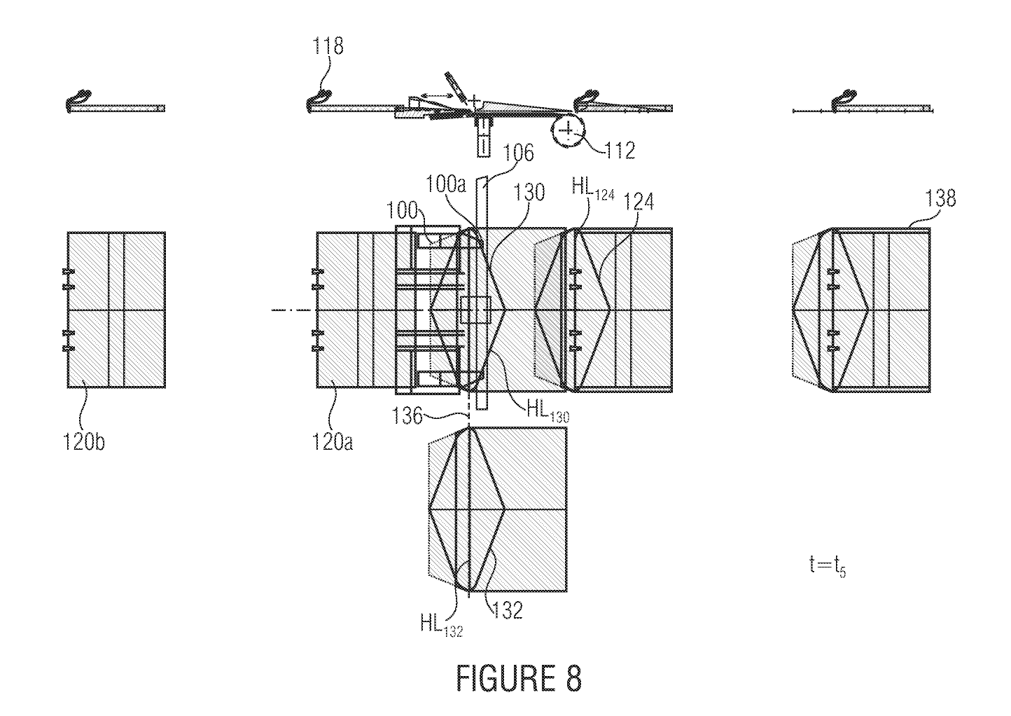

In FIG. 8, the situation after t=t₅ is shown. The filling aids 100 were activated and moved from the rest position into that position wherein their tips 100a have been moved into the envelope 130. The filling material 120a has already reached the filling station and was moved—between the lateral guides and by means of the filling aids 100—in the direction of the envelope with the aid of the filling slide 118. In FIG. 8, the envelope 124 has already been completely discharged from the filling station.

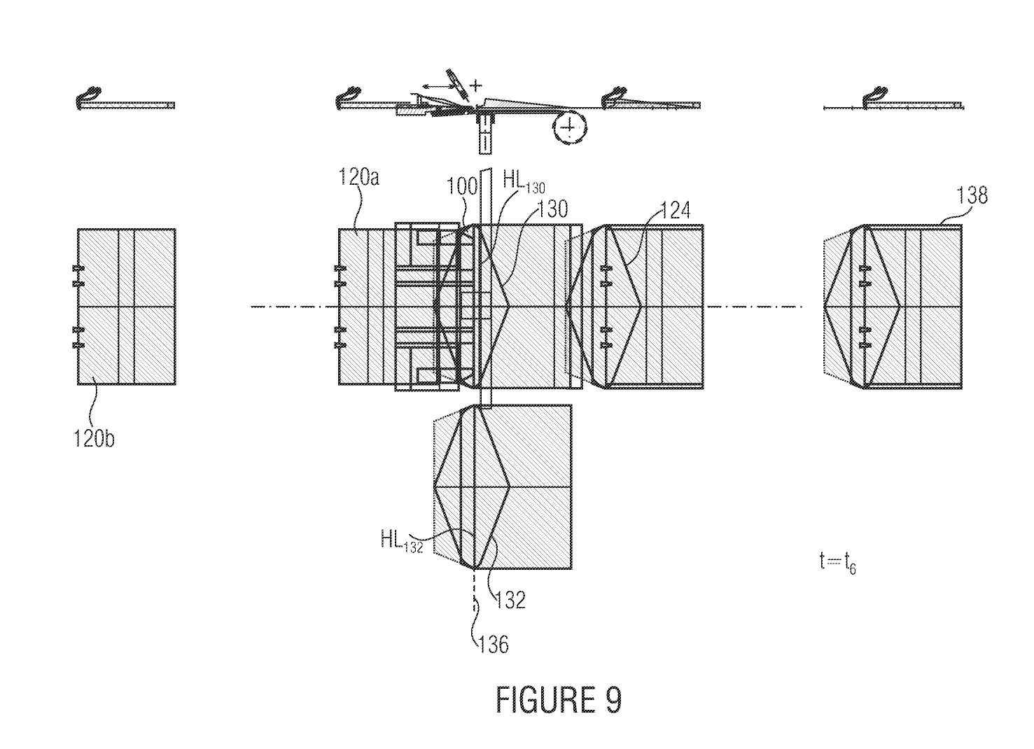

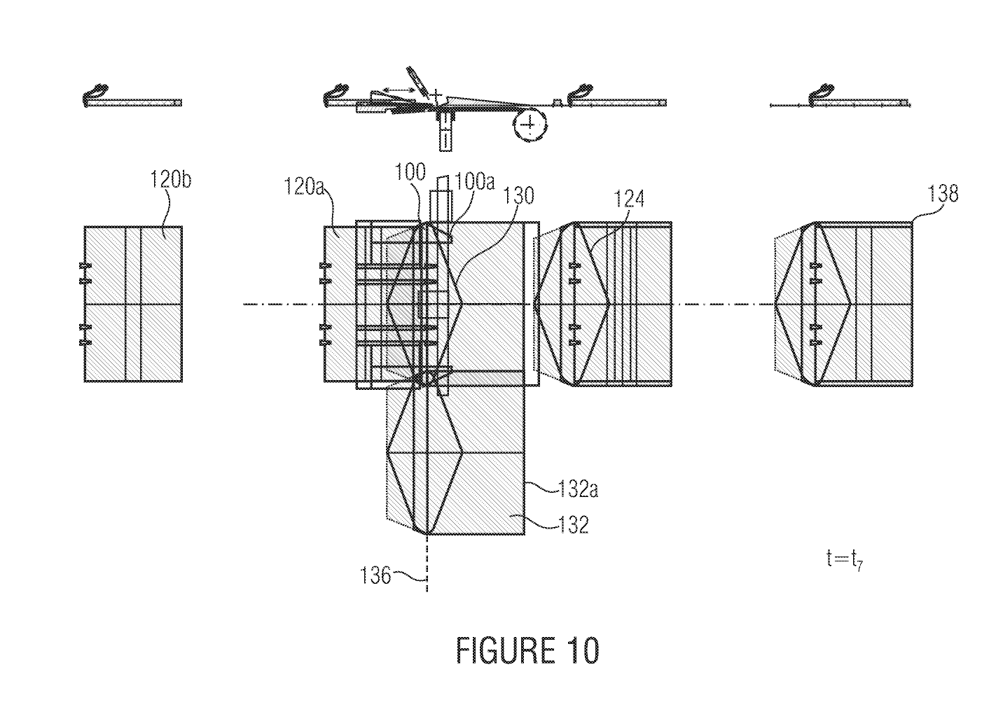

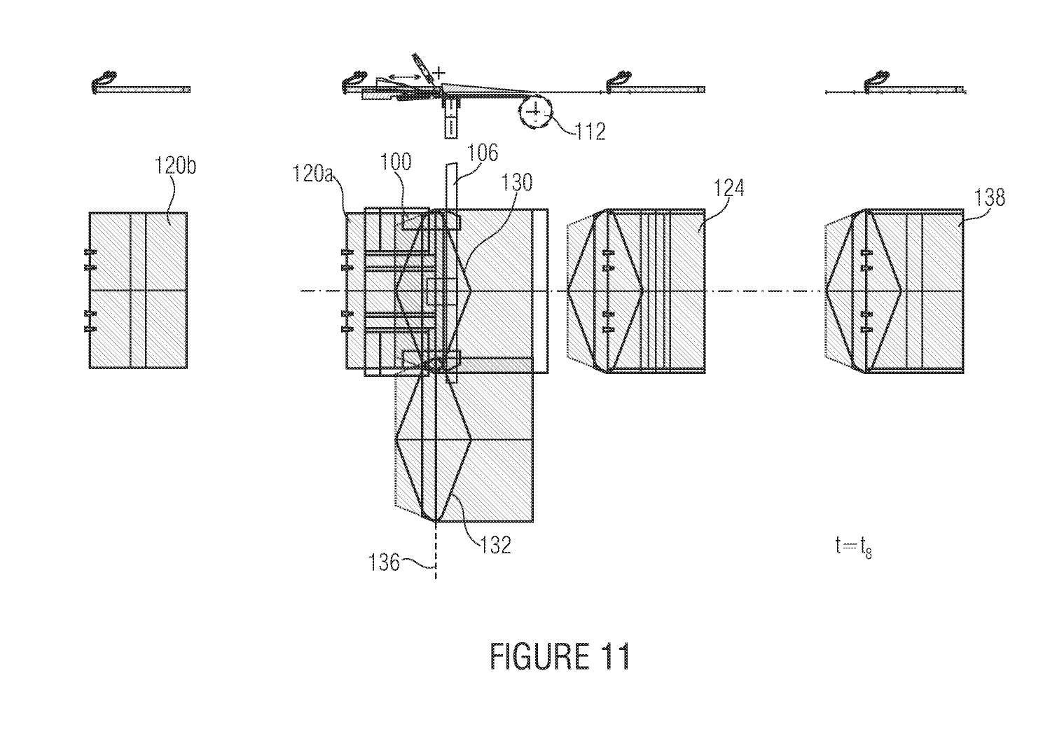

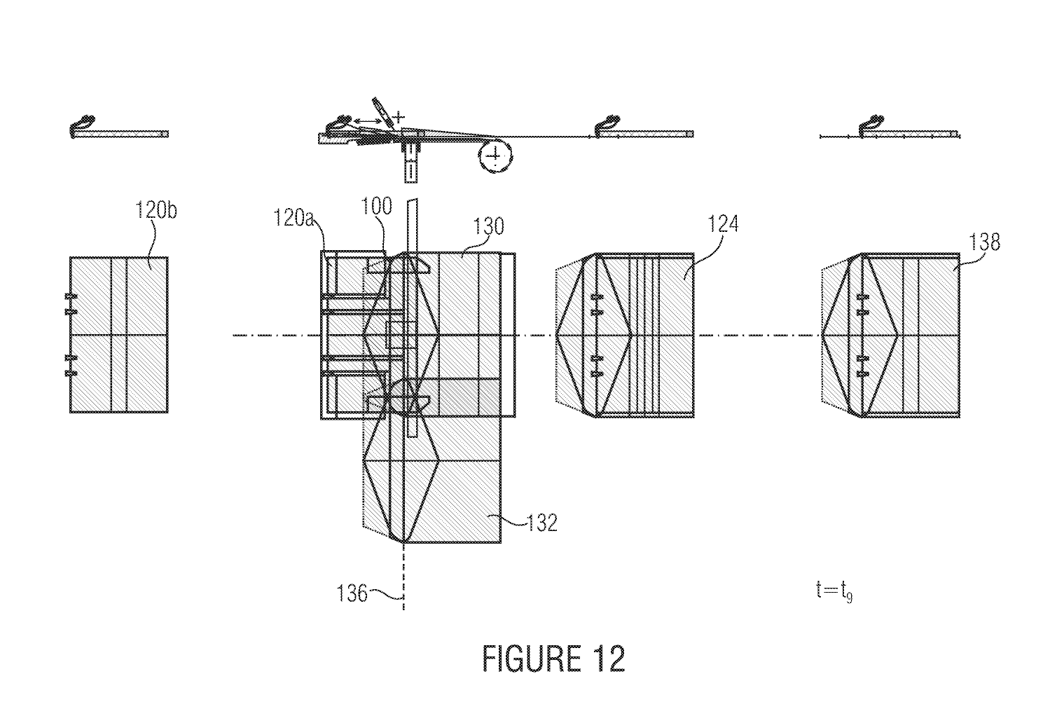

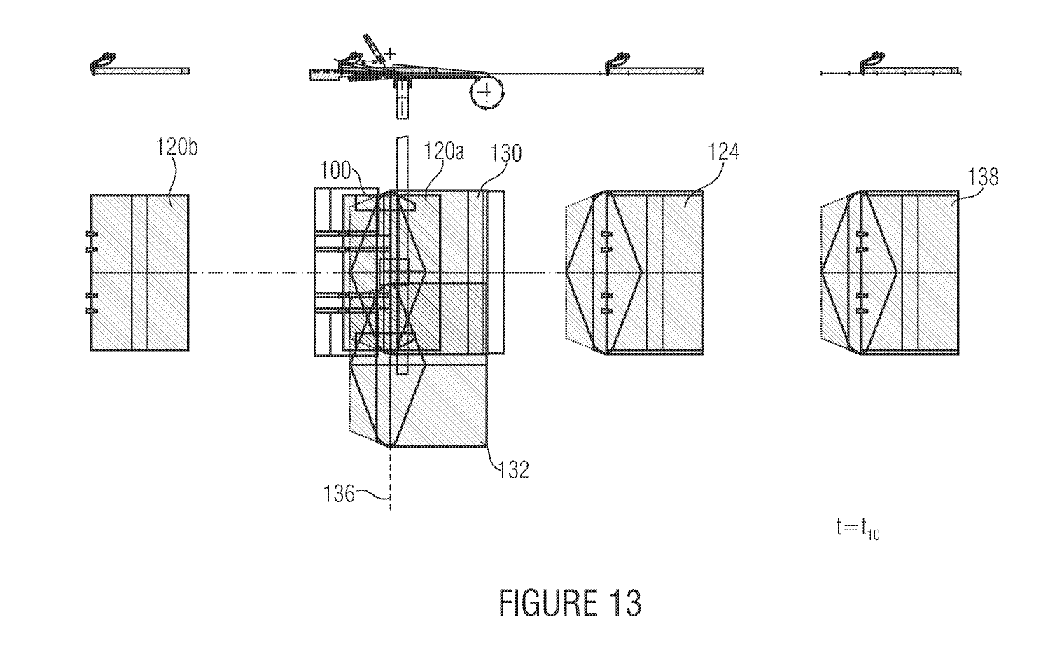

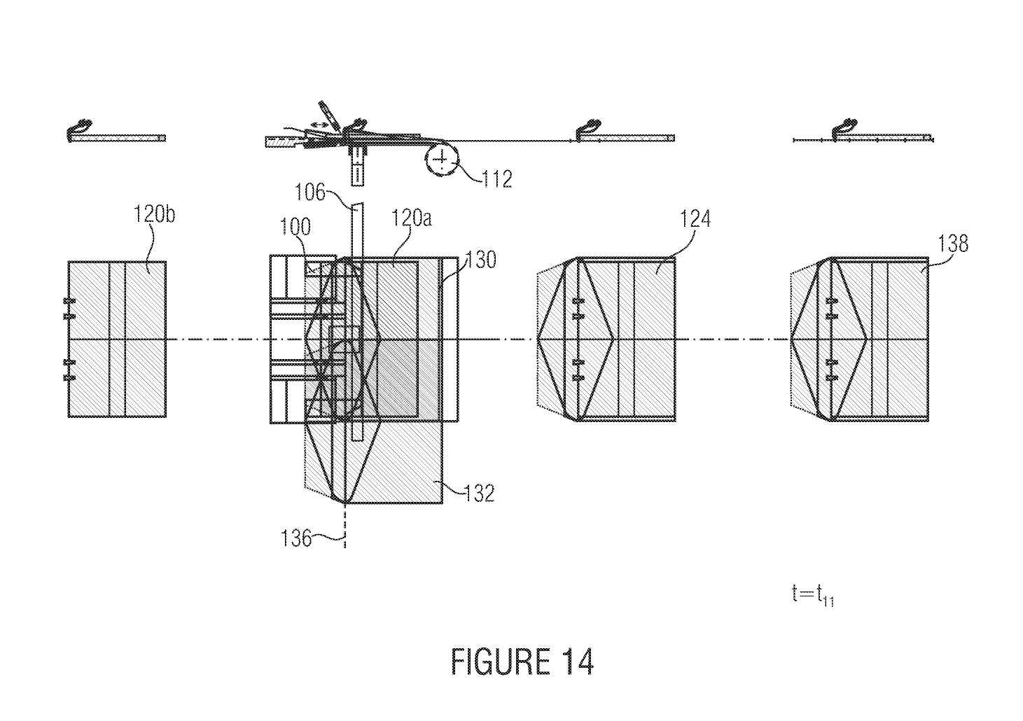

FIGS. 9 to 14 show the introduction, performed in the time period from t=t₆ to t=t₁₁, of the filling material 120a into the envelope 130, so that at the time t=t₁₂/tₒ, the situation described by means of FIG. 3 arises. Starting from this situation, the next cycle of introducing the group of envelopes 120b into the envelope 132 starts. FIG. 10 shows the filling position wherein the filling aids 100 are completely inserted into the envelope. As can be seen in FIG. 10, the front ends 100a are inserted into the envelope 130 and are located in a position which is downstream from the suction belt 106 in the material direction. The filling material 120a has its front edge, as seen in the envelope transport direction, at the hinge line HL₁₃₀. Envelope separation via the wheel 112 and/or the corresponding bay is no longer active, and the subsequent envelope already moves into the filling area. As may be seen from FIGS. 10 to 13, the envelope 132 starts to move into the filling area of the filling station, an envelope bottom 132a of same (see FIG. 10) being held in the bay 112b of the wheel 112, which is now located in that position in which the bay 112a was in FIG. 1. Once the material 120a has been moved beyond the filling aid in the transport direction, the filling aid is returned to the starting position.

In accordance with embodiments of the invention, the envelope flap is located at the position 110 shown in FIG. 1, specifically, it is located below the paper travel sheet 101. The filling aids 100 are advantageously displaceable in the format area. The envelope is positioned in the filling station by means of the suction-belt transport device 106, the envelope possibly being opened, once it has been positioned, via blow air tabs 116 by means of pressurized air. The filling aids serve to move into the opened envelope so as to span it open.

In accordance with embodiments of the invention, a subsequent envelope is not inserted, in order to avoid movement overlap, until a preceding envelope is located in the filling position, and a filled transport is not output until the new envelope has been completely inserted.

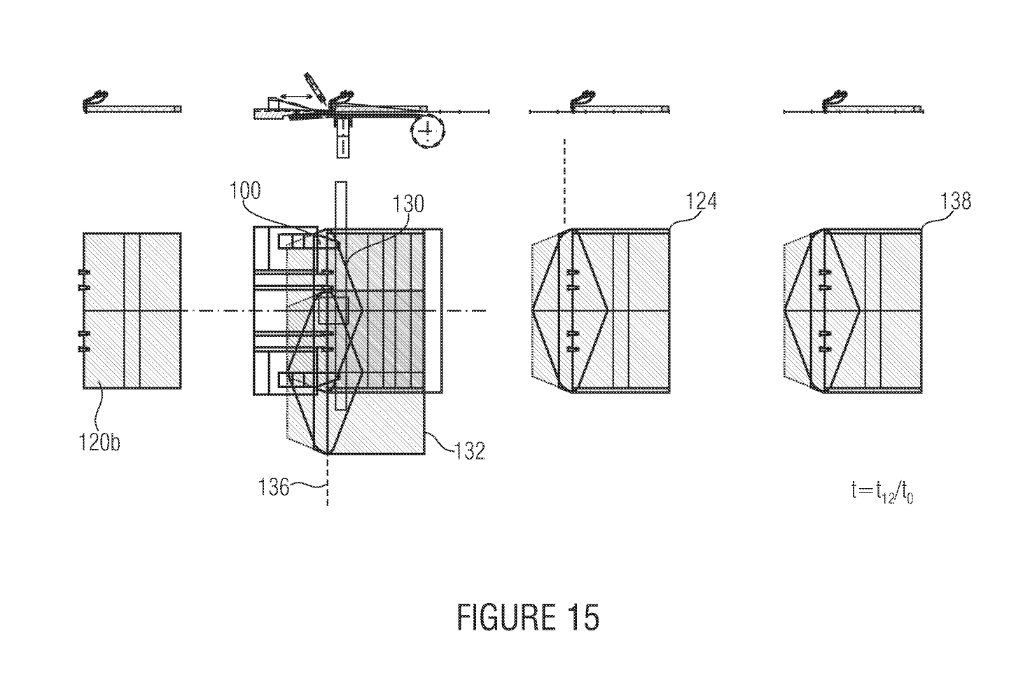

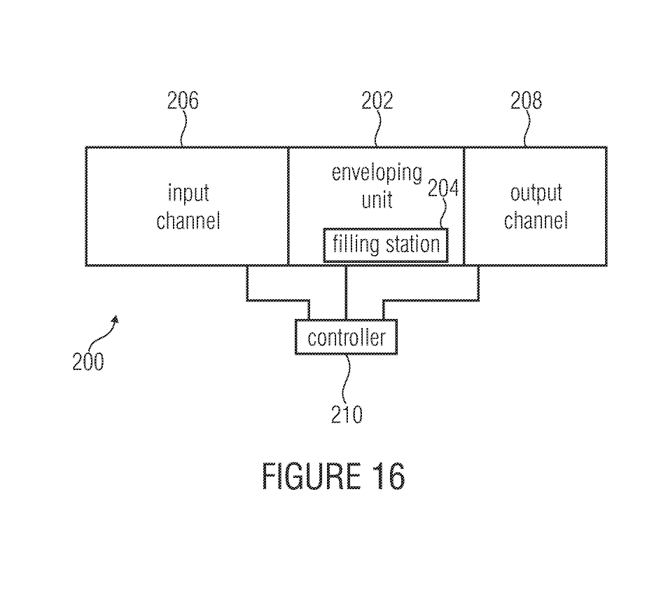

FIG. 16 shows a schematic representation of a paper handling system 200 which includes an enveloping machine 202 comprising a filling station 204 in accordance with embodiments of the present invention. The paper handling system 200 may include one or more input channels, only one input channel 206 being shown by way of example in FIG. 15. The input channel includes different paper handling components, such as a cutter, a merger, a collating station, a folding unit and/or a gathering web comprising one or more insert leaders. In addition, the system 200 includes at least one output channel 208 for further processing of the enveloped goods, for example a franking unit or a sorting unit. In addition, a controller 210 is provided which controls the components in the input channel 206, in the output channel 208 and in the enveloping unit 202 as well as the filling station 204. Even though FIG. 15 shows a central controller 210, embodiments of the invention are not limited to such a configuration; rather, the controller may also be arranged within each of the components in a decentralized manner, and the corresponding control signals for the subsequent components are transmitted between the components.

Embodiments were described by means of a filling station which includes movable filling aids. It shall be noted at this point that the invention is not limited to such an implementation. Rather, the filling station may also operate without any filling aids.

Even though some aspects have been described within the context of a device, it is understood that said aspects also represent a description of the corresponding method, so that a block or a structural component of a device is also to be understood as a corresponding method step or as a feature of a method step. By analogy therewith, aspects that have been described in connection with or as a method step also represent a description of a corresponding block or detail or feature of a corresponding device. Some or all of the method steps may be performed while using a hardware device, such as a microprocessor, a programmable computer or an electronic circuit. In some embodiments, some or several of the most important method steps may be performed by such a device.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. A filling station for filling an envelope comprising a filling material, the filling station comprising:
a filling area,
a holder configured to hold an envelope to be filled in the filling area in a stationary manner while it is being filled, and to release the filled envelope once it has been filled,
at least one opener configured to open the envelope to be filled,
an inserter configured to insert a filling material into the opened envelope to be filled, and
a transport unit configured to move a subsequent envelope into the filling area while the envelope to be filled is being filled, and
the opener being configured to open the subsequent envelope before the filled envelope has completely left the filling area.

2. The filling station as claimed in claim 1, wherein the holder is configured to hold an envelope at its envelope flap.

3. The filling station as claimed in claim 1, comprising:
at least one movable filling aid configured to be moved into the envelope to be filled.

4. The filling station as claimed in claim 3, wherein the filling aid is configured to guide the material in the filling process.

5. The filling station as claimed in claim 3, wherein the filling aid is configured to be moved into the subsequent envelope once filling of the envelope has been completed and before removal of the filled envelope from the filling station is completed.

6. The filling station as claimed in claim 1, wherein the transport unit comprises an envelope feeder configured to feed the subsequent envelope so as to hold part of the subsequent envelope in a downwardly deflected manner in relation to the rest of the envelope and away from the envelope to be filled, and to release the deflected part of the envelope before filling of the envelope to be filled is completed.

7. The filling station as claimed in claim 1, wherein the holder is configured to hold the subsequent envelope in the filling area once the filled envelope has been released.

8. The filling station as claimed in claim 6, wherein the envelope feeder is configured to hold an envelope bottom of the subsequent envelope in a downwardly deflected manner in relation to the rest of the subsequent envelope.

9. The filling station as claimed in claim 6, wherein the envelope feeder is configured to receive the subsequent envelope below the filling area.

10. The filling station as claimed in claim 6, wherein the envelope feeder comprises a rotatable member or one or more movable pairs of fingers so as to hold part of the subsequent envelope in a downwardly deflected manner in relation to the rest of the envelope and away from the envelope to be filled.

11. The filling station as claimed in claim 10, wherein the rotatable member comprises one or more rollers, one or more wheels, or a drum, the envelope feeder comprising one or more receptacles arranged along the circumference of the rotatable member.

12. The filling station as claimed in claim 6, wherein the envelope feeder comprises a transport device configured to feed the subsequent envelope.

13. The filling station as claimed in claim 12, wherein the transport device is configured to feed the subsequent envelope in the material transport direction, counter to the material transport direction, or perpendicularly to the material transport direction.

14. The filling station as claimed in claim 12, wherein the transport is configured to receive a plurality of envelopes in a shingled manner.

15. The filling station as claimed in claim 12, wherein the transport comprises a suction-belt transport device.

16. The filling station as claimed in claim 1, comprising a removal unit configured to discharge the filled envelope and to be activated once the filling material has been inserted into the envelope.

17. The filling station as claimed in claim 16, wherein the removal unit comprises a suction drum arranged above the filling area.

18. The filling station as claimed in claim 1, wherein the inserter comprises at least one filling slide configured to insert a filling material into the opened envelope.

19. The filling station as claimed in claim 18, wherein the filling slide is further configured to discharge the filled envelope.

20. The filling station as claimed in claim 1, which are effective to fill a plurality of envelopes such that
(a) the holder holds a first envelope in the filling area for receiving the filling material,
(b) the opener opens the first envelope, inserts a movable filling aid into the first envelope, and the first envelope is filled,
(c) an envelope feeder moves a subsequent envelope into the filling area while the first envelope is being filled, and holds part of the second envelope in a deflected manner in relation to the rest of the second envelope and away from the first envelope, and
(d) the holder releases the first envelope once it has been filled and holds, as soon as the first envelope has left the holder, the second envelope in the filling area, and the envelope feeder releases the deflected part of the second envelope,
wherein steps (b) to (d) for filling a plurality of envelopes are repeated, the opener opening the second envelope before the first envelope has completely left the filling area.

21. A paper handling system, comprising:
one or more paper handling components for providing a filling material;
a filling station as claimed in claim 1; and
a controller effective to control the paper handling component and the filling station.

22. A method of filling an envelope with a filling material, comprising:
holding, in a stationary manner, an envelope to be filled in a filling area,
opening the envelope to be filled,
introducing a filling material into the opened envelope to be filled,
moving a subsequent envelope into the filling area while the envelope to be filled is being filled,
releasing the filled envelope, and
opening the subsequent envelope before the filled envelope has completely left the filling area.

23. The method as claimed in claim 19, further comprising:
moving at least one movable filling aid into the envelope to be filled.

24. The method as claimed in claim 22, further comprising:
feeding the subsequent envelope, part of the subsequent envelope being held in a deflected manner in relation to the rest of the envelope and away from the envelope to be filled, and being released before filling of the envelope to be filled has been completed.

25. The method as claimed in claim 22, further comprising:
holding the subsequent envelope in the filling area once the filled envelope has been released.

26. The method as claimed in claim 24, wherein an envelope bottom of the subsequent envelope is held in a downwardly deflected manner in relation to the rest of the subsequent envelope.
